(19) United States
(12) Patent Application Publication
(10) Pub. No.: US 2026/0057025 A1
(43) Pub. Date: Feb. 26, 2026

(54) CONTENT QUERY

(71) Applicants: Beijing Zitiao Network Technology Co., Ltd., Beijing (CN); Lemon Inc., Grand Cayman (KY)

(72) Inventors: Xinzhu Jia, Beijing (CN); Kaijie Dong, Beijing (CN); Jiachen Wang, Singapore (SG); Yue Zhao, Beijing (CN); Li Wen, Aaron Sng, Singapore (SG)

(21) Appl. No.: 19/310,741

(22) Filed: Aug. 26, 2025

(30) Foreign Application Priority Data
Aug. 26, 2024 (WO) PCT/CN2024/114646

(51) Int. Cl. G06F 16/9538

(52) U.S. Cl. CPC G06F 16/9538

(57) ABSTRACT

According to embodiments of the present disclosure, a solution for content query are provided. The method includes: in response to receiving a user query, determining a plurality of matching degrees between the user query and a plurality of query modes; determining, based on the plurality of matching degrees, whether a query result for the user query is to comprise a predetermined type of content being generated based on at least one data source using a machine learning model; in response to determining that the query result for the user query is to comprise the predetermined type of content, extracting target content matching with the user query from a content database comprising the predetermined type of content; and causing the target content to be presented in a query result page for the user query according to a visual style corresponding to the predetermined type.

### CROSS-REFERENCE

This application claims priority to PCT International Application No. PCT/CN2024/114646, filed on Aug. 26, 2024 and entitled “METHOD, APPARATUS, DEVICE, STORAGE MEDIUM AND PROGRAM PRODUCT FOR CONTENT QUERY”, which is incorporated herein by reference in its entirety.

### FIELD

Example embodiments of the present disclosure generally relate to the field of computers, and in particular, to a method and an apparatus for content query, an electronic device, a computer-readable storage medium and a computer program product.

### BACKGROUND

With the development of information technologies, various terminal devices may provide various services to people in terms of work and life. For example, a terminal device may be deployed with an application providing a service. The terminal device or application may provide to the user a content query function, a content browsing function, and the like, to assist the user in using the terminal device or application. The application may provide various pages, and receive a user query from the user via the page and provide to the user a query result page corresponding to the user query.

### SUMMARY

In a first aspect of the present disclosure, a method for content query is provided. The method includes: in response to receiving a user query, determining a plurality of matching degrees between the user query and a plurality of query modes; determining, based on the plurality of matching degrees, whether a query result for the user query is to include a predetermined type of content being generated based on at least one data source using a machine learning model; in response to determining that the query result for the user query is to include the predetermined type of content, extracting target content matching with the user query from a content database including the predetermined type of content; and causing the target content to be presented in a query result page for the user query according to a visual style corresponding to the predetermined type.

In a second aspect of the present disclosure, an electronic device is provided. The electronic device includes: at least one processing unit; and at least one memory coupled to the at least one processing unit and storing instructions for execution by the at least one processing unit, the instructions, when executed by the at least one processing unit, causing the electronic device to perform operations comprising: in response to receiving a user query, determining a plurality of matching degrees between the user query and a plurality of query modes; determining, based on the plurality of matching degrees, whether a query result for the user query is to include a predetermined type of content being generated based on at least one data source using a machine learning model; in response to determining that the query result for the user query is to include the predetermined type of content, extracting target content matching with the user query from a content database including the predetermined type of content; and causing the target content to be presented in a query result page for the user query according to a visual style corresponding to the predetermined type.

In a third aspect of the present disclosure, there is provided a computer-readable storage medium having a computer program stored thereon which, when executed by a processor, causes the processor to perform operations comprising: in response to receiving a user query, determining a plurality of matching degrees between the user query and a plurality of query modes; determining, based on the plurality of matching degrees, whether a query result for the user query is to include a predetermined type of content being generated based on at least one data source using a machine learning model; in response to determining that the query result for the user query is to include the predetermined type of content, extracting target content matching with the user query from a content database including the predetermined type of content; and causing the target content to be presented in a query result page for the user query according to a visual style corresponding to the predetermined type.

It should be understood that the content described in this summary is not intended to limit the essential or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 illustrates a schematic diagram of an architecture for content query according to some embodiments of the present disclosure;

FIG. 3 illustrates a schematic diagram of an example of a query result page according to some embodiments of the present disclosure;

FIG. 4 illustrates a flowchart of a method for content query according to some embodiments of the present disclosure;

FIG. 5 illustrates an example structural block diagram of an apparatus for content query according to some embodiments of the present disclosure; and

FIG. 6 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for the purposes of example only and are not intended to limit the scope of the present disclosure.

In the description of the embodiments of the present disclosure, the terms “comprising” and the like should be understood to include “comprising but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, performing one step “in response to A” does not imply that this step is performed immediately after “A”, but may include one or more intermediate steps.

It may be understood that the data involved in the technical solution (including but not limited to the data itself, the obtaining, using, storing, or deleting of the data) should follow the requirements of the corresponding laws and regulations and related regulations.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations, and the authorization of the user is obtained.

For example, in response to receiving an active request from a user, prompt information is sent to the user to explicitly prompt the user that the operation he/she requested to execute will need to obtain and use personal information of the user, so that the user can autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select whether he/she “agrees” or “disagrees” to provide personal information to the electronic device.

It may be understood that the foregoing process of notification and obtaining of a user authorization are merely illustrative, and do not constitute a limitation on implementations of the present disclosure, and other manners of meeting related laws and regulations may also be applied to implementations of the present disclosure.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network,” which terms are used interchangeably herein.

A “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include various hidden layers, thereby increasing the depth of the network. Various layers of the neural network are connected in sequence such that the output of the previous layer is provided as an input to the next layer, where the input layer receives the input of the neural network and the output of the output layer serves as the final output of the neural network. Each layer of the neural network includes one or more nodes (also referred to as processing nodes or neurons), and each node processes the input from the previous layer.

Generally, machine learning may roughly include three phases, a training phase, a test phase, and an application phase (also referred to as an inference phase). In the training phase, a given model may be trained by using a large scale of training data, continuously and iteratively updating parameter values until the model obtains consistent inference results that meet an expected objective from the training data. By training, the model may be considered as being capable of learning an association between input and output from training data (also referred to as a mapping from input to output). The trained model may be trained with determined parameter values. In the test stage, a test input is applied to the trained model, to test whether the model may provide a correct output, thereby determining the performance of the model. The test phase may sometimes be fused into the training phase. In the application or inference phase, the trained model may be used to process the actual model inputs based on the parameter values obtained from the training to determine the corresponding model outputs.

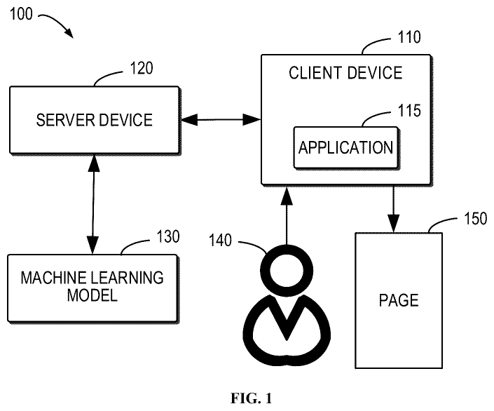

FIG. 1 illustrates a schematic diagram of an example environment 100 in which embodiments of the present disclosure may be implemented. In this example environment 100, an application 115 is installed in the client device 110. The user 140 may interact with the application 115 via the client device 110 and/or an attached device of the client device 110. For example, the application 115 may capture voice of the user 140 via an audio capture device (e.g., a microphone) of the client device 110, may capture an image of the user 140 via an image capture device (e.g., a camera) of the client device 110, and/or the like.

In the embodiments of the present disclosure, the application 115 may be any suitable application having a search function (i.e., a content query function), which may, for example, be a browser application, a social network application, a media item application, or the like. In the environment 100, if the application 115 is activated, the client device 110 may present a page 150 of the application 115. The page 150 may include any suitable page that may be provided by the application 115, such as a search page, a query result page, a content browsing page, a personal homepage of a user, and the like. In some embodiments, the client device 110 and/or the application 115 may receive a user query via the page 150 and provide a query result corresponding to the user query to the user via the page 150.

In some embodiments, a communication connection is established between the client device 110 and the server device 120. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In the embodiments of the present disclosure, the client device 110 and the server device 120 may implement signaling interaction via the communication connection therebetween, to supply a service to the application 115.

As shown in FIG. 1, the server device 120 may call a machine learning model 130 to support the search function of the application 115 based on the output of the machine learning model 130. The machine learning model 130 may be deployed on the server device 120, or may be deployed on other devices. The machine learning model 130 may be based on any suitable model structure including, but not limited to, a Transformer model, a convolutional neural network (CNN), a recurrent neural network (RNN), a deep neural network (DNN), or the like. In some embodiments, the machine learning model 130 may be based on a language model (LM). The language model be equipped with the question-answering capability by learning from a large corpus. The machine learning model 130 may also be based on other suitable models. It would be appreciated that the machine learning model 130 may include one or more machine learning models. If the machine learning model 130 includes a plurality of machine learning models, the plurality of machine learning models may have different uses and functions, which is not limited in the present disclosure.

The client device 110 may be any type of mobile terminal, fixed terminal, or portable terminal, including a mobile handset, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, including accessories and peripherals of these devices, or any combination thereof. In some embodiments, the client device 110 may also support any type of interface for a user (such as a “wearable” circuit, etc.).

The server device 120 may be a standalone physical server, or a server cluster or a distributed system composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server device 120 may include, for example, a computing system/server, such as a mainframe, an edge computing node, a computing device in a cloud environment, or the like.

It should be understood that the structures and functions of the various elements in the environment 100 are described for the purposes of example only and do not imply any limitation to the scope of the present disclosure.

Traditionally, in response to receiving a user query, a query result page corresponding to the user query presents a query result including a plurality of pieces of content. For example, the query result presented in the query result page may include a plurality of media items. If the query result corresponding to the user query includes a large scale of content, the user may experience poor efficiency in browsing the query result, which may affect the information integrity obtained by the user.

In view of this, according to the embodiments of the present disclosure, an improved solution for content query is provided. According to the solution of the embodiments of the present disclosure, in response to receiving the user query, a plurality of matching degrees between the user query and the plurality of query modes is determined. Based on the plurality of matching degrees, whether the query result for the user query is to include the content of the predetermined type is determined, and the content of the predetermined type is generated based on the at least one data source using the machine learning model. In response to determining that the query result for the user query is to include the content of the predetermined type, target content matching with the user query is extracted from a content database including the predetermined type of content. In the query result page for the user query, the target content is presented according to a visual style corresponding to the predetermined type.

In this way, target content matching with the user query may be extracted from the content database, and may be presented in the query result page in a specific visual style. This provides convenience for the user to obtain the answer (that is, the target content) corresponding to the user query in the query result page, thereby improving the efficiency of retrieving content for the user.

Some example embodiments of the present disclosure will be described below with continued reference to the accompanying drawings.

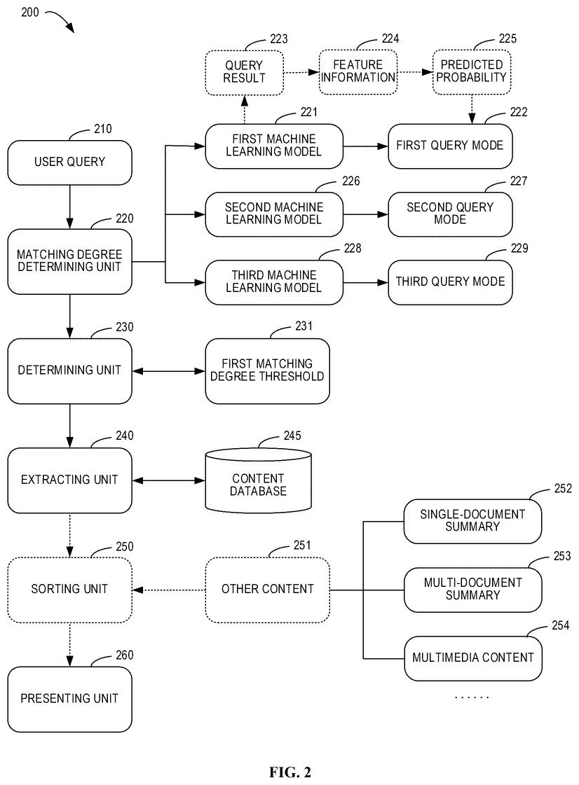

FIG. 2 shows a schematic diagram of an architecture 200 for content query according to some embodiments of the present disclosure. For case of description, it is illustrated as an example where the architecture 200 is implemented at the server device 120. It would be appreciated that, if the architecture 200 being implemented at the client device 110 is taken as an example for description, some operations described with reference to the client device 110 may require the assistance of the server device 120 to be completed. It would be appreciated that the operations performed by the client device 110 may be specifically performed by a related application installed on the client device 110. The architecture 200 will be described with reference to the environment 100 of FIG. 1. The architecture 200 relates to a matching degree determining unit 220, a determining unit 230, an extracting unit 240, and a presenting unit 260.

The client device 110 may receive a user query 210 from the user 140 via the page 150. The user query 210 may be any suitable type of query including, but not limited to, a voice type, an action type, an image type, a text type, and the like. The client device 110 may provide the received user query 210 to the server device 120 via communication with the server device 120. The server device 120 may provide the user query 210 to the matching degree determining unit 220 in response to receiving the user query 210.

The matching degree determining unit 220 may determine a plurality of matching degrees between the user query 210 and the plurality of query modes in response to receiving the user query 210. The plurality of query modes may include at least a first query mode 222 (also referred to as a resource missing mode) that indicates whether the query result may satisfy a user requirement corresponding to the user query, a second query mode 227 (also referred to as a strong questioning and answering mode) that indicates the user query being related to the knowledge questioning and answering, and a third query mode 229 (also referred to as an information search mode) that indicates the user query being related to information search. Certainly, the plurality of query modes may further include any other suitable query modes, which are not limited in the present disclosure. It is generally found that presenting, to a user, content automatically generated by a model in a particular visual style in certain query modes is more beneficial. Therefore, for the current user query, it may be determined whether the content automatically generated by the model needs to be provided in the query result page of the user query by judging whether the user query matches certain predefined query modes.

In a specific manner of determining the plurality of matching degrees corresponding to the plurality of query modes, in some embodiments, the matching degree determining unit 220 may determine a first matching degree between the user query 210 and the first query mode 222 by determining, using a trained first machine learning model 221 (for example, a click prediction model), a predicted probability 225 that the query result 223 in the query result page for the user query 210 is clicked. The predicted probability 225 and the first matching degree may be positively correlated, that is, the higher the predicted probability 225 of the query result 223 being clicked, the higher the first matching degree. This is because, if it is predicted that a user is more willing to click on a matching search result in a search result page, it may no longer be necessary to provide content that is automatically generated and summarized by the model in the search result page.

Specifically, the matching degree determining unit 220 may obtain a plurality of query results 223 that are presented in the query result page and match the user query 210. Each query result 223 may include any suitable type of content, such as documents, web pages, media items (e.g., images, videos, audio, etc.), and the like. It would be appreciated that the plurality of query results 223 presented in the query result page may be part of all the query results that match the user query 210. For example, if all the query results matching with the user query 210 include 100 query results, the plurality of query results presented in the query result page may be 20 query results in the 100 query results. The 20 query results may be 20 query results in the 100 query results that are randomly determined, or may be 20 query results in the 100 query results that have the highest matching degree with the user query 210. It may be understood that the number of the plurality of query results 223 may be associated with the configuration of the query result page. For example, if the query result page is configured to present 20 query results at a time, the number of the plurality of query results 223 may be 20, and if the query result page is configured to present 50 query results at a time, the number of the plurality of query results 223 may be 50.

The matching degree determining unit 220 may extract at least one type of feature information 224 of respective ones of the plurality of query results 223. The at least one type of feature information 224 of each query result 223 may include, for example, a click through rate (CTR) of each query result, a relevance (rel) of each query result, authority of each query result, and the like. The matching degree determining unit 220 may provide at least one type of feature information 224 of respective ones of the plurality of query results 223 to the first machine learning model 221. For example, the first machine learning model 221 may determine, based on the at least one type of feature information 224 of respective ones of the plurality of query results 223, a predicted probability 225 that the query result 223 in the query result page is clicked. The output of the first machine learning model 221 may be, for example, a value between 0 and 1. The matching degree determining unit 220 may determine, based on this value, the predicted probability 225 that the query result 223 in the query result page is clicked (for example, if the model output is 0.7, then the predicted probability 225 is 70%), so as to determining the first matching degree between the user query 210 and the first query mode 222.

In some embodiments, the matching degree determining unit 220 may determine a second matching degree between the user query 210 and a second query mode 227 using a trained second machine learning model 226 (for example, a strong questioning and answering intent estimation model), and may determine a third matching degree between the user query 210 and a third query mode 229 using a trained third machine learning model 228 (for example, an information knowledge intent model). For example, the second machine learning model 226 and the third machine learning model 228 may respectively output a value of 0 and 1 based on the user query 210, and the matching degree determining unit 220 may determine the second matching degree and the third matching degree based on the values output by the second machine learning model 226 and the third machine learning model 228, respectively. It would be appreciated that the first machine learning model 221, the second machine learning model 226, and the third machine learning model 228 may each be the machine learning model 130, and these three machine learning models may be constructed based on any suitable model structures. This is because with strong questioning and answering intent or information indication intent, the user may be more interested in knowledge or information search, or he/she is more desirable to seek for a certain fact. At this point, it may be more desirable for the user to provide, in the search result page, summarized content matching with the user query that is generated automatically by the model.

In some embodiments, a set of samples for training the second machine learning model 226 and the set of samples for training the third machine learning model 228 may each include a plurality of sample queries and a plurality of labels. Each label in the set of samples for training the second machine learning model 226 may indicate a labeled matching degree between a corresponding sample query and the second query mode 227, and each label in the set of samples for training the third machine learning model 228 may indicate a labeled matching degree between a corresponding sample query and the third query mode 229. It would be appreciated that the two sets of samples may be the same set of samples, and in this case, each label in the set of samples may indicate a labeled matching degree between a corresponding sample query and the second query mode 227 and a labeled matching degree between the corresponding sample query and the third query mode 229. The two sets of samples may also be different sets of samples, in which case the sample queries in the two sets of samples may be identical, partially the identical, or different. In addition, even if a plurality of sample queries in the two sets of samples are the same, the labels corresponding to a same sample query in the two sets of samples are different.

For ease of description, the set of samples for training the second machine learning model 226 and the set of samples for training the third machine learning model 228 are collectively referred to as a target set of samples. Each label in the target set of samples may be manually determined (e.g., manually labelled) by the user in advanced. In some embodiments, to reduce the labor cost, a training device (which may be, for example, the server device 120 or any other suitable electronic device) for training the second machine learning model 226 and/or the third machine learning model 228 may obtain the first set of sample queries and the labeled matching degrees corresponding to the first set of sample queries. The number of sample queries included in the first set of sample queries is less than the number of sample queries included in the target set of samples. For example, the first set of sample queries may include 2000 sample queries, and the target set of samples may include 20000 sample queries.

The training device may provide the first set of sample queries and the first prompt input to the trained language model together, to determine a predicted matching degree between each of the first set of sample queries and the second query mode and/or the third query mode based on the first prompt input using the language model. It may be understood that, if the target set of samples is a sample set for training the second machine learning model 226, the first set of sample queries are also a set of sample queries for training the second machine learning model 226, and the training device may determine the predicted matching degree between each of the first set of sample queries and the second query mode using the language model. If the target set of samples is a sample set for training the third machine learning model 228, the first set of sample queries are also a set of sample queries for training the third machine learning model 228, and the training device may determine the predicted matching degree between each of the first set of sample queries and the third query mode using the language model. If the target set of samples is both the set of samples for training the second machine learning model 226 and the set of samples for training the third machine learning model 228, the first set of sample queries are also a set of sample queries for training the second machine learning model 226 and a set of sample queries for training the third machine learning model 228. The training device may determine projected matching degrees between each of the first set of sample queries and the second query mode as well as the third query mode, respectively.

The first prompt input indicates a rating requirement of the language model for the first set of sample queries. It may be understood that the first prompt input (referred to simply as the first prompt input corresponding to the second query mode) used to determine the predicted matching degree between each of the first set of sample queries and the second query mode is different from the first prompt input (the first prompt input corresponding to the third query mode) used to determine the predicted matching degree between each of the first set of sample queries and the third query mode. The first prompt input corresponding to each query mode may indicate how to determine a score for the first set of sample queries with respect to the query mode.

The training device may determine a difference between the predicted matching degree corresponding to each of the first set of sample queries output by the language model and the labeled matching degree corresponding to each of the first set of sample queries, and adjust the first prompt input based on the difference. For example, the predicted matching degree and the labeled matching degree may both be a numerical value between 0 and 1, and the training device may determine a difference between a numerical value corresponding to the predicted matching degree and a numerical value corresponding to the labeled matching degree, where the difference is also the difference between the predicted matching degree and the labeled matching degree. The adjustment target for adjusting the first prompt input is to reduce difference, that is, lower the difference. The training device may determine that the adjustment of the first prompt is completed, in response to the difference being less than a threshold (e.g., 0).

The training device may use the language model to determine predicted matching degrees between respective sample queries of the second set of sample queries and the second query mode and/or the third query mode based on the adjusted first prompt input, as labeled matching degrees of the second set of sample queries. The second set of sample queries may be obtained in any suitable manner. In some embodiments, the training device may obtain the second set of sample queries by means of the language model and the first set of sample queries. The second set of sample queries may be sample queries generated by the language model with reference to the first set of sample queries. The number of sample queries included in the second set of sample queries may, for example, be greater than the number of sample queries included in the first set of sample queries. The process of the training device generating the second set of sample queries based on the first set of sample queries may also be referred to as an extension to the first set of sample queries.

The training device may provide the adjusted first prompt input and the second set of sample queries to the language model together, and determine, based on the output of the language model, a projected matching degree between each of the second set of sample queries and the second query mode and/or the third query mode. The training device may determine the predicted matching degree corresponding to each of the second set of sample queries as the labeled matching degree corresponding to each of the second set of sample queries. The training device may determine a target set of samples based on the first set of sample queries and the second set of sample queries. That is, the plurality of sample queries in the target set of samples are the total of the first set of sample queries and the second set of sample queries. The label corresponding to each sample query in the target set of samples may be, for example, a labeled matching degree corresponding to the sample query.

The matching degree determining unit 220 may provide the determined plurality of matching degrees to the determining unit 230. The determining unit 230 may determine, based on the plurality of matching degrees, whether the query result for the user query 210 is to include a predetermined type of content. The predetermined type of content may be generated, for example, using a machine learning model (e.g., machine learning model 130) based on at least one data source. The at least one data source may include, but is not limited to, a web page, an image, a document, a video, or the like. In some embodiments, the determining unit 230 may obtain a first matching degree threshold 231 corresponding to each matching degree, and determine, based on a comparison result between each matching degree in the plurality of matching degrees and the corresponding first matching degree threshold 231, whether the query result is to include the predetermined type of content.

In some embodiments, the determining unit 230 may determine that the query result is to include the predetermined type of content in response to determining that at least one of the plurality of matching degrees satisfies a first matching degree threshold 231 corresponding there to. A case in which the matching degree corresponding to a certain query mode meets the corresponding first matching degree threshold may be referred to as the user query 210 matching the query mode. The user query 210 may match at least one query mode. For example, if the plurality of query modes includes three query modes, the matching degree determining unit 220 may determine three matching degrees corresponding to the three query modes. The determining unit 230 may determine three first matching degree thresholds 231 corresponding to the three query modes, and may determine, in response to the matching degree of any one of the three query modes satisfying the corresponding first matching degree threshold 231, that the query result is to include the predetermined type of content. Certainly, if the matching degrees of any two query modes satisfy the corresponding first matching degree thresholds 231, or if the matching degrees of all the three query modes satisfy the corresponding first matching degree thresholds 231, the determining unit 230 may determine that the query result is to include the predetermined type of content. For ease of description, the following uses an example in which the user query 210 only has one matching degree satisfying a corresponding first matching degree threshold in the plurality of matching degrees for the multiple query modes (that is, the user query 210 only matches one query mode in the plurality of query modes).

It would be appreciated that, in some embodiments, for the first query mode 222, in response to that the first matching degree of the first query mode 222 does not reach the first matching degree threshold 231 corresponding to the first query mode 222, the determining unit 230 may determine that the first matching degree of the first query mode 222 satisfies the first matching degree threshold 231 corresponding to the first query mode 222. That is, the determining unit 230 may determine that the user query 210 matches the first query mode 222 when the first matching degree is relatively small.

For the second query mode 227 and/or the third query mode 229, in response to the second matching degree of the second query mode 227 reaching the first matching degree threshold 231 corresponding to the second query mode 227 and/or the third matching degree of the third query mode 229 reaching the first matching degree threshold 231 corresponding to the third query mode 229, the determining unit 230 may determine that the second matching degree of the second query mode 227 satisfies the first matching degree threshold 231 corresponding to the second query mode 227 and/or the third matching degree of the third query mode 229 satisfies the first matching degree threshold 231 corresponding to the third query mode 229. That is, the determining unit 230 may determine that the user query 210 matches the second query mode 227 and/or the third query mode 229 when the second matching degree and/or the third matching degree are relatively large.

The extracting unit 240 may extract the target content matching with the user query 210 from the content database 245 including the predetermined type of content, in response to determining that the query result for the user query 210 is to include the predetermined type of content. The content in the content database 245 may be generated by the server device 120 in advance using a machine learning model, such as the machine learning model 130. Alternatively or additionally, in some embodiments, the content in the content database 245 may also be generated by other electronic devices in advance using a machine learning model. In this case, the server device 120 may obtain the content database 245 including the predetermined type of content from other electronic devices via a communication connection with other electronic devices. For case of description, the following uses an example in which the content in the content database 245 is generated by the server device 120 using a machine learning model.

Regarding the generation of the content in the content database 245, in some embodiments, the server device 120 may generate, using a machine learning model (for example, the machine learning model 130), a first answer and a second answer that match the reference query, and content included in the first answer may be, for example, is with more detail than content included in the second answer. The first answer may be referred to as a long answer, for example, and the second answer may be referred to as a short answer, for example. The server device 120 may determine respective quality scores of the first answer and the second answer, and determine a retention policy for the first answer and the second answer based on the respective quality scores of the first answer and the second answer. The server device 120 may determine the respective quality scores of the first answer and the second answer in any suitable manner, and the present disclosure does not limit the specific manner of determining the quality score. The retention policy may indicate whether a corresponding answer is to be retained.

In some embodiments, the server device 120 may determine the quality score of each of the first answer and the second answer by detecting whether the first answer and the second answer include a predetermined search term. The predetermined search term may be, for example, a search term indicating that the machine learning model cannot generate an accurate answer for the user query 210. For example, the predetermined search term may include, but is not limited to, “I'm sorry”, “sorry”, “cannot generate”, “cannot search”, and the like. The server device 120 may determine that the quality score of the first answer/the second answer is lower in response to the first answer or second answer including the predetermined search term, and may determine that the quality score of the first answer/the second answer is higher in response to the first answer or second answer not including the predetermined search term. For example, the server device 120 may determine, in response to the quality score corresponding to any one of the first answer and the second answer being lower, that the retention policy corresponding to the answer indicates not retaining the answer.

For example, only if the retention policy indicates that both the first answer and the second answer are retained, the server device 120 may store the first answer and the second answer in the content database 245 as the predetermined type of content matching with the reference query. The server device 120 may, for example, store the reference query, the first answer, and the second answer in the content database 245 in the form of “reference query-first answer-second answer”. In some embodiments, the server device 120 may further determine a semantic difference between the first answer and the second answer corresponding to each reference query. The server device 120 may retain the two answers only if the semantic difference between the first answer and the second answer is less than the threshold. Therefore, the server device 120 may perform cross validation on the first answer and the second answer corresponding to the reference query, which may improve the accuracy of the first answer and the second answer.

With respect to the specific manner in which the target content matching with the user query 210 is extracted from the content database 245, in some embodiments, the server device 120 may retrieve in the content database 245 based on the user query 210 to find a reference query similar to the user query 210. For example, the server device 120 may determine a similarity between the plurality of reference queries in the content database 245 and the user query 210. For example, the server device 120 may determine content corresponding to a set of reference queries (for example, a first answer and a second answer corresponding to each query in the set of queries), among the plurality of reference queries, whose corresponding similarities are higher than a threshold as the target content matching with the user query 210.

In some embodiments, the server device 120 may directly provide the target content to the presenting unit 260. The presenting unit 260 may cause the target content to be presented according to a visual style corresponding to the predetermined type in the query result page for the user query. The visual style corresponding to the predetermined type may include at least a card style. That is, the presenting unit 260 may present the target content in the form of a card in the query result page. In some embodiments, regarding the presenting location of the target content in the query result page, the server device 120 may determine the presenting location of the target content in the query result page based on at least the user query 210 and the plurality of matching degrees corresponding to the plurality of query modes.

Each query mode may correspond to a plurality of matching degree thresholds. In some embodiments, the first matching degree threshold 231 corresponding to the first query mode 222 may be a maximum matching degree threshold among a plurality of matching degree thresholds corresponding to the first query mode 222. Taking the first query mode 222 corresponding to three matching degree thresholds (for example, the first matching degree threshold 231, the second matching degree threshold, and the third matching degree threshold) as an example, the relationship of the three matching degree thresholds may be the first matching degree threshold 231>the second matching degree threshold >the third matching degree threshold. The server device 120 (specifically, for example, the determining unit 230) may determine that the query result of the user query 210 is to include the predetermined type of content, in response to the first matching degree corresponding to the first query mode 222 satisfying the first matching degree threshold 231 (that is, the first matching degree threshold 231 is not reached).

For the first query mode 222, a smaller matching degree threshold may correspond to a more preferred location in the query result page. In an example, it is assumed that the first location is the uppermost location in the query result page, the second location is the location below the first location, the third location is the location under the second location. If the first matching degree corresponding to the first query mode 222 only satisfy the corresponding first matching degree threshold 231 (for example, less than the first matching degree threshold 231 but greater than the second matching degree threshold), the presenting unit 260 may determine that the presenting location of the target content in the query result page is the third location. If the matching degree corresponding to the query mode satisfies the second matching degree threshold but does not satisfy the third matching degree threshold (for example, less than the second matching degree threshold but greater than the third matching degree threshold), the presenting unit 260 may determine that the presenting location of the target content in the query result page is the second location. If the matching degree corresponding to the query mode satisfies the third matching degree threshold (for example, less than the third matching degree threshold), the presenting unit 260 may determine that the presenting location of the target content in the query result page is the first location.

Similarly, for any one of the second query mode 227 and the third query mode 229, the first matching degree threshold 231 may be, for example, a minimum matching degree threshold among a plurality of matching degree thresholds corresponding to the query mode. Taking the query mode corresponding to three matching degree thresholds (also for example, the first matching degree threshold 231, the second matching degree threshold, and the third matching degree threshold) as an example, the relationship of the three matching degree thresholds may be the first matching degree threshold 231<the second matching degree threshold <the third matching degree threshold. The server device 120 (specifically, for example, the determining unit 230) may determine, in response to the matching degree corresponding to the query mode satisfying the first matching degree threshold 231 (that is, reaching the first matching degree threshold 231), that the query result of the user query 210 is to include the predetermined type of content.

For any one of the second query mode 227 and the third query mode 229, a greater matching degree threshold may correspond to the more preferred location in the query result page. Taking the first location being the uppermost location in the queried result page, the second location being the location below the first location, and the third location being the location below the second location as an example, if the matching degree corresponding to the query mode only satisfies the corresponding first matching degree threshold 231 (for example, greater than the first matching degree threshold 231 but less than the second matching degree threshold), the presenting unit 260 may determine that the presenting location of the target content in the query result page is the third location. If the matching degree corresponding to the query mode satisfies the second matching degree threshold but does not satisfy the third matching degree threshold (for example, greater than the second matching degree threshold but less than the third matching degree threshold), the presenting unit 260 may determine that the presenting location of the target content in the query result page is the second location. If the matching degree corresponding to the query mode satisfies the third matching degree threshold (for example, greater than the third matching degree threshold), the presenting unit 260 may determine that the presenting location of the target content in the query result page is the first location.

In some embodiments, the presenting unit 260 may further determine the presenting location of the target content in the query result page based on the specific content of the target content (for example, the text included in the target content), the query result corresponding to the user query 210, the configuration information on the query result page by the user in advance, and the like. Exemplarily, the presenting unit 260 may determine whether the query result matching with the user query 210 includes content configured to be located in the specified presenting location (for example, user information, entity card, feature answer, etc. corresponding to the user query 210). If it is determined that the query result matching with the user query 210 includes content configured to be at the specified presenting location, the presenting unit 260 may determine the presenting location of the target content as a further presenting location other than the specified presenting location based at least on the plurality of matching degrees. For example, if the query result includes content configured to be located at the first location, even if the presenting unit 260 determines that the presenting location of the target content in the query result page is the first location based on the matching degree, the presenting unit 260 is configured to determine the presenting location of the target content as the second location located below the first location or any other suitable location, so as to avoid the content configured to be at the first location.

In some embodiments, if it is determined in any other suitable manner that other content 251 needs to be presented according to the visual style corresponding to the predetermined type (e.g., the card style), the architecture 200 may also involve a sorting unit 250. Other content 251 may include, for example, at least one piece of content, such as a single-document summary 252, a multi-document summary 253, multimedia content 254, and/or the like. The sorting unit 250 may sort the target content and the other content 251 based on a plurality of features respectively corresponding to the target content and the other content 251. The plurality of features herein may include, for example, query features (e.g., intent, timeliness, and/or authority), doc features (e.g., usefulness, authenticity, and/or readability), query-doc features (e.g., correlation, and/or CTR), and the like.

For example, the sorting unit 250 may calculate the quality score corresponding to each piece of content in the target content and the other content 251 by using a predetermined fusion formula. For example, the fusion formula may be, for example, Quality Score=(Para. 1+Feature 1)^{Para.2}+ (Para. 1+Feature 2)^{Para.2}+(Para. 1+Feature3)^{Para.2}+ . . . + (Para. 1+Feature N)^{Para.2}, the Para. 1 and Para. 2 herein may be parameters that are configured in advance, and Feature 1 to Feature N are a plurality of features required for sorting. The sorting unit 250 may further sort the target content and the other content 251 based on the quality score corresponding to respective pieces of content. In some embodiments, the sorting unit 250 may determine the number of pieces of content that are allowed to be presented in the visual style corresponding to the predetermined type (for example, the card style) in the query result page, which may also be understood as determining the number of cards allowed to be presented in the query result page. This number may be pre-configured by the user, or may be default.

If only one card is allowed to be presented in the query result page, the sorting unit 250 may determine, from the target content and other content 251, one piece of content with the highest corresponding quality score, and provide the piece of content to the presenting unit 260, so that the content is presented in the query result page according to the visual style corresponding to the predetermined type. Similarly, if a plurality of cards are allowed to be presented in the query result page, the sorting unit may determine, based on the number of the plurality of cards, a plurality of pieces of content with the highest corresponding quality scores from the target content and other content 251, and provide the plurality of pieces of content to the presenting unit 260, so that the plurality of pieces of content are presented in the query result page according to the visual style corresponding to the predetermined type.

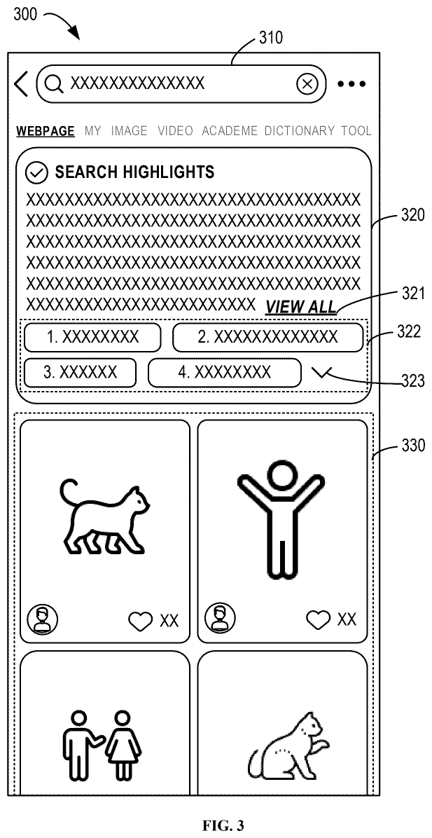

FIG. 3 illustrates a schematic diagram of an example 300 of a query result page according to some embodiments of the present disclosure. As shown in FIG. 3, an example 300 includes an input box 310, a card 320, and an area 330. The client device 110 may, for example, receive a user query via input box 310. For example, the client device 110 may present a query result corresponding to the user query in the area 330. The card 320 may be presented with target content extracted from the content database by the server device 120. If the required presentation size for the target content exceeds the size of the card 320, the card 320 may include a control 321. The client device 110 may switch to a detail page of the target content in response to receiving a trigger operation on the control 321, and present the target content in the detail page. The card 320 may also include an area 322. The area 322 may present at least one data source of the target content (e.g., the data source 1 to the data source 4 shown in the figure). If the number of the at least one data source is large, only some of the at least one data source may be presented in the area 322. In this case, the area 322 may include a control 323. The client device 110 may present all of the at least one data source in response to receiving a trigger operation on the control 323.

In summary, according to the embodiments of the present disclosure, the target content matching with the user query may be extracted from the content database, and the target content may be presented in the query result page in a specific visual style. This provides convenience for the user to obtain the answer (that is, the target content) corresponding to the user query in the query result page, thereby improving the efficiency of retrieving the content for the user.

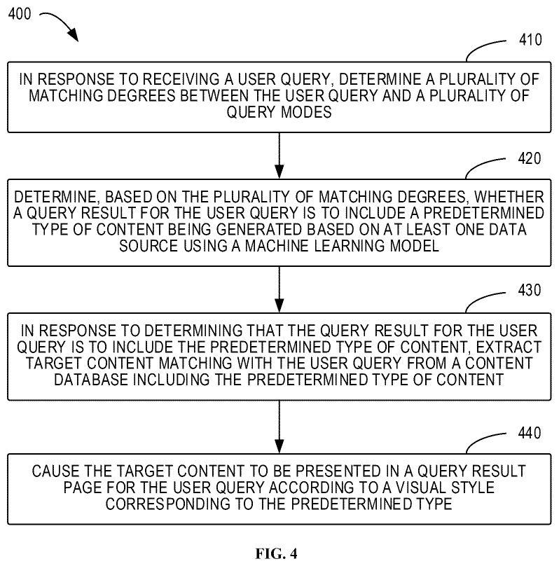

FIG. 4 illustrates a flowchart of a content query method 400 according to some embodiments of the present disclosure. The method 400 may be implemented at the server device 120. The method 400 will be described with reference to the environment 100 of FIG. 1.

At block 410, the server device 120 determines, in response to receiving the user query, a plurality of matching degrees between the user query and a plurality of query modes.

At block 420, the server device 120 determines, based on the plurality of matching degrees, whether a query result for the user query is to include a predetermined type of content being generated based on at least one data source using a machine learning model.

At block 430, the server device 120 extracts, in response to determining that the query result for the user query is to include the predetermined type of content, target content matching with the user query from a content database including the predetermined type of content.

At block 440, the server device 120 causes the target content to be presented according to a visual style corresponding to the predetermined type in the query result page for the user query.

In some embodiments, determining the plurality of matching degrees between the user query and the plurality of query modes includes: determining a first matching degree between the user query and a first query mode by determining, using a trained first machine learning model, a predicted probability of a query result in the query result page for the user query being clicked, the first query mode indicating whether a query result satisfies a user requirement corresponding to a user query; determining a second matching degree between the user query and a second query mode by using a trained second machine learning model, the second query mode indicating that a user query is related to knowledge questioning and answering; and determining a third matching degree between the user query and a third query mode using a trained third machine learning model, the third query mode indicating that a user query is related to information search.

In some embodiments, determining the first matching degree between the user query and the first query mode includes: obtaining a plurality of query results matching with the user query, wherein the plurality of search results are to be presented in the query result page; extracting at least one type of feature information of respective ones of the plurality of query results; and determining, using the first machine learning model, the predicted probability of the query result in the query result page being clicked based on the at least one type of feature information of respective ones of the plurality of query results.

In some embodiments, the second machine learning model and/or the third machine learning model are trained based on a target set of samples, the target set of samples includes a plurality of sample queries and a plurality of labels, each label indicating a labeled matching degree between a corresponding sample query and the second query mode, and/or a labeled matching degree between a corresponding sample query and the third query mode.

In some embodiments, the target set of samples is obtained by: determining, using a language model and based on a first prompt input, at least one predicted matching degree between each sample query of a first set of sample queries and at least one of the second query mode or the third query mode, wherein the first prompt input indicates a rating requirement of the language model for the first set of sample queries, and the first set of sample queries have respective labeled matching degrees; adjusting the first prompt input based on a difference between the labeled matching degree corresponding to each of the first set of sample queries and the predicted matching degree; and determining, using the language model and based on the adjusted first prompt input, at least one predicted matching degree between each of a second set of sample queries and at least one of the second query mode or the third query mode, as a labeled matching degree of a sample query in the second set of sample queries.

In some embodiments, determining, based on the plurality of matching degrees, whether the query result for the user query is to include the predetermined type of content includes: in response to determining that at least one matching degree of the plurality of matching degrees satisfies a corresponding first matching degree threshold, determining that the query result is to include the predetermined type of content.

In some embodiments, causing the target content to be presented according to the visual style corresponding to the predetermined type includes: determining a presenting location of the target content in the query result page based at least on the plurality of matching degrees; and causing the target content to be presented according to the visual style corresponding to the predetermined type at the presenting location of the query result page.

In some embodiments, determining the presenting location of the target content in the query result page includes: determining whether the query result matching with the user query includes content configured to be at a specified presenting location; and if it is determined that the query result matching with the user query includes the content configured to be located at the specified presenting location, determining the presenting location of the target content as a further presenting location other than the specified presenting location based at least on the plurality of matching degrees.

In some embodiments, the predetermined type of content in the content database is generated by: generating a first answer and a second answer matching with a reference query using a machine learning model, wherein content included in the first answer is with more detail than content included in the second answer; determining a retention policy for the first answer and the second answer based on respective quality scores of the first answer and the second answer; and if the retention policy indicates that both the first answer and the second answer are retained, storing the first answer and the second answer in the content database as the predetermined type of content that matches the reference query.

In some embodiments, the visual style corresponding to the predetermined type includes at least a card style.

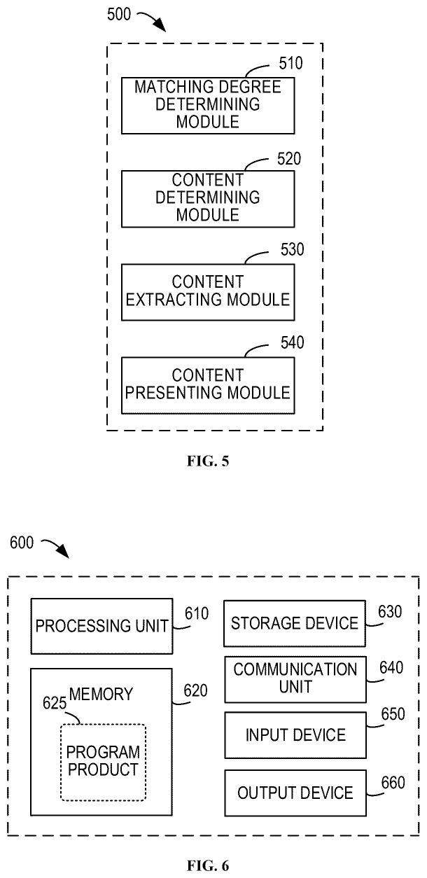

Embodiments of the present disclosure also provide a corresponding apparatus for implementing the above method or process. FIG. 5 illustrates an example structural block diagram of an apparatus 500 for content query according to some embodiments of the present disclosure. The apparatus 500 may be implemented or included in the server device 120. The various modules or components in the apparatus 500 may be implemented by hardware, software, firmware, or any combination thereof.

As shown in FIG. 5, the apparatus 500 includes a matching degree determining module 510 configured to determine, in response to receiving a user query, a plurality of matching degrees between the user query and a plurality of query modes. The apparatus 500 further includes a content determining module 520 configured to determine, based on the plurality of matching degrees, whether a query result for the user query is to include a predetermined type of content being generated based on at least one data source using a machine learning model. The apparatus 500 further includes a content extracting module 530 configured to extract, in response to determining that the query result for the user query is to include the predetermined type of content, target content matching with the user query from a content database including the predetermined type of content. The apparatus 500 further includes a content presenting module 540 configured to cause the target content to be presented in a query result page for the user query according to a visual style corresponding to the predetermined type.

In some embodiments, the matching degree determining module 510 is further configured to: determine a first matching degree between the user query and a first query mode by determining, using a trained first machine learning model, a predicted probability of a query result in the query result page for the user query being clicked, the first query mode indicating whether a query result satisfies a user requirement corresponding to a user query; determine a second matching degree between the user query and a second query mode by using a trained second machine learning model, the second query mode indicating that a user query is related to knowledge questioning and answering; and determine a third matching degree between the user query and a third query mode using a trained third machine learning model, the third query mode indicating that a user query is related to information search, the third query mode indicating that a user query is related to information search.

In some embodiments, the matching degree determining module 510 is further configured to obtain a plurality of query results matching with the user query, where the plurality of search results are to be presented in the query result page; extract at least one type of feature information of respective ones of the plurality of query results; and determine, using the first machine learning model, the predicted probability of the query result in the query result page being clicked based on the at least one type of feature information of respective ones of the plurality of query results.

In some embodiments, the second machine learning model and/or the third machine learning model are trained based on a target set of samples, the target set of samples includes a plurality of sample queries and a plurality of labels, each label indicating a labeled matching degree between a corresponding sample query and the second query mode, and/or a labeled matching degree between a corresponding sample query and the third query mode.

In some embodiments, the target set of samples is obtained by: determining, using a language model and based on a first prompt input, at least one predicted matching degree between each sample query of a first set of sample queries and at least one of the second query mode or the third query mode, wherein the first prompt input indicates a rating requirement of the language model for the first set of sample queries, and the first set of sample queries have respective labeled matching degrees; adjusting the first prompt input based on a difference between the labeled matching degree corresponding to each of the first set of sample queries and the predicted matching degree; and determining, using the language model and based on the adjusted first prompt input, at least one predicted matching degree between each of a second set of sample queries and at least one of the second query mode or the third query mode, as a labeled matching degree of a sample query in the second set of sample queries.

In some embodiments, the content determining module 520 is further configured to determine that the query result is to include the predetermined type of content, in response to determining that at least one matching degree of the plurality of matching degrees satisfies a corresponding first matching degree threshold.

In some embodiments, the content presenting module 540 is further configured to: determine a presenting location of the target content in the query result page based at least on the plurality of matching degrees; and cause the target content to be presented according to the visual style corresponding to the predetermined type at the presenting location of the query result page.

In some embodiments, the content presenting module 540 is further configured to: determine whether a query result matching with the user query includes content configured to be located at a specified presenting location; and if it is determined that the query result matching with the user query includes the content configured to be located at the specified presenting location, determine the presenting location of the target content as a further presenting location other than the specified presenting location based at least on the plurality of matching degrees.

In some embodiments, the predetermined type of content in the content database is generated by: generating a first answer and a second answer matching with a reference query using a machine learning model, where content included in the first answer is with more detail than content included in the second answer; determine a retention policy for the first answer and the second answer based on respective quality scores of the first answer and the second answer; and if the retention policy indicates that both the first answer and the second answer are retained, storing the first answer and the second answer in the content database as the predetermined type of content matching with the reference query.

In some embodiments, the visual style corresponding to the predetermined type includes at least a card style.

The units and/or modules included in the apparatus 500 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 500 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

It should be understood that one or more of the above methods may be performed by a suitable electronic device or a combination of electronic devices. Such an electronic device or a combination of electronic devices may include, for example, the server device 120 in FIG. 1.

FIG. 6 illustrates a block diagram of an electronic device 600 in which one or more embodiments of the present disclosure may be implemented. It should be understood that the electronic device 600 illustrated in FIG. 6 is merely an example and should not constitute any limitation on the functionality and scope of the embodiments described herein. The electronic device 600 shown in FIG. 6 may be configured to implement the server device 120 in FIG. 1 or the apparatus 500 in FIG. 5.

As shown in FIG. 6, the electronic device 600 is in the form of a general-purpose electronic device. Components of the electronic device 600 may include, but are not limited to, one or more processors or processing units 610, a memory 620, a storage device 630, one or more communications units 640, one or more input devices 650, and one or more output devices 660. The processing unit 610 may be an actual or virtual processor and may perform various processes according to programs stored in the memory 620. In a multiprocessor system, a plurality of processing units execute computer executable instructions in parallel, so as to improve the parallel processing capability of the electronic device 600.

The electronic device 600 typically includes a number of computer storage media. Such media may be any available media that are accessible by electronic device 600, including, but not limited to, volatile and non-volatile media, removable and non-removable media. The memory 620 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium such as a flash drive, a magnetic disk, or any other medium that can be used to store information and/or data and that can be accessed within the electronic device 600.

The electronic device 600 may further include additional removable/non-removable, volatile/nonvolatile storage media. Although not shown in FIG. 6, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 implements communication with other electronic devices through a communication medium. In addition, functions of components of the electronic device 600 may be implemented by a single computing cluster or a plurality of computing machines, and these computing machines can communicate through a communication connection. Thus, the electronic device 600 may operate in a networked environment using logical connections to one or more other servers, network personal computers (PCs), or another network node.

The input device 650 may be one or more input devices such as a mouse, keyboard, trackball, etc. The output device 660 may be one or more output devices such as a display, speaker, printer, etc. The electronic device 600 may also communicate with one or more external devices (not shown) such as a storage device, a display device, or the like through the communication unit 640 as required, and communicate with one or more devices that enable a user to interact with the electronic device 600, or communicate with any device (e. g., a network card, a modem, or the like) that enables the electronic device 600 to communicate with one or more other electronic devices. Such communication may be performed via an input/output (I/O) interface (not shown).

According to an example implementation of the present disclosure, a computer readable storage medium is provided, on which a computer-executable instruction is stored, wherein the computer executable instruction is executed by a processor to implement the above-described method. According to an example implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is example, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/We claim:

1. A method for content query, comprising:
in response to receiving a user query, determining a plurality of matching degrees between the user query and a plurality of query modes;
determining, based on the plurality of matching degrees, whether a query result for the user query is to comprise a predetermined type of content being generated based on at least one data source using a machine learning model;
in response to determining that the query result for the user query is to comprise the predetermined type of content, extracting target content matching with the user query from a content database comprising the predetermined type of content; and
causing the target content to be presented in a query result page for the user query according to a visual style corresponding to the predetermined type.

2. The method of claim 1, wherein determining the plurality of matching degrees between the user query and the plurality of query modes comprises:
determining a first matching degree between the user query and a first query mode by determining, using a trained first machine learning model, a predicted probability of a query result in the query result page for the user query being clicked, the first query mode indicating whether a query result satisfies a user requirement corresponding to a user query;
determining a second matching degree between the user query and a second query mode by using a trained second machine learning model, the second query mode indicating that a user query is related to knowledge questioning and answering; and
determining a third matching degree between the user query and a third query mode using a trained third machine learning model, the third query mode indicating that a user query is related to information search.

3. The method of claim 2, wherein determining the first matching degree between the user query and the first query mode comprises:
obtaining a plurality of query results matching with the user query, wherein the plurality of search results are to be presented in the query result page;
extracting at least one type of feature information of respective ones of the plurality of query results; and
determining, using the first machine learning model, the predicted probability of the query result in the query result page being clicked based on the at least one type of feature information of respective ones of the plurality of query results.

4. The method of claim 2, wherein the second machine learning model and/or the third machine learning model are trained based on a target set of samples, the target set of samples comprises a plurality of sample queries and a plurality of labels, each label indicating a labeled matching degree between a corresponding sample query and the second query mode, and/or a labeled matching degree between a corresponding sample query and the third query mode.

5. The method of claim 4, wherein the target set of samples is obtained by:
determining, using a language model and based on a first prompt input, at least one predicted matching degree between each sample query of a first set of sample queries and at least one of the second query mode or the third query mode, wherein the first prompt input indicates a rating requirement of the language model for the first set of sample queries, and the first set of sample queries have respective labeled matching degrees;
adjusting the first prompt input based on a difference between the labeled matching degree corresponding to each of the first set of sample queries and the predicted matching degree; and
determining, using the language model and based on the adjusted first prompt input, at least one predicted matching degree between each of a second set of sample queries and at least one of the second query mode or the third query mode, as a labeled matching degree of a sample query in the second set of sample queries.

6. The method of claim 1, wherein determining, based on the plurality of matching degrees, whether the query result for the user query is to comprise the predetermined type of content comprises:
in response to determining that at least one matching degree of the plurality of matching degrees satisfies a corresponding first matching degree threshold, determining that the query result is to comprise the predetermined type of content.

7. The method of claim 1, wherein causing the target content to be presented according to the visual style corresponding to the predetermined type comprises:
determining a presenting location of the target content in the query result page based at least on the plurality of matching degrees; and
causing the target content to be presented at the presenting location of the query result page according to the visual style corresponding to the predetermined type.

8. The method of claim 7, wherein determining the presenting location of the target content in the query result page comprises:
determining whether a query result matching with the user query comprises content configured to be located at a specified presenting location; and
in response to determining that the query result matching with the user query comprises the content configured to be located at the specified presenting location, determining the presenting location of the target content as a further presenting location other than the specified presenting location based at least on the plurality of matching degrees.

9. The method of claim 1, wherein the predetermined type of content in the content database is generated by:
generating a first answer and a second answer matching with a reference query using a machine learning model, wherein content comprised in the first answer is with more detail than content comprised in the second answer;
determining a retention policy for the first answer and the second answer based on respective quality scores of the first answer and the second answer; and
in response to the retention policy indicating that both the first answer and the second answer are retained, storing the first answer and the second answer in the content database as the predetermined type of content matching with the reference query.

10. The method of claim 1, wherein the visual style corresponding to the predetermined type at least comprises a card style.

11. An electronic device, comprising:
at least one processing unit; and
at least one memory coupled to the at least one processing unit and storing instructions for execution by the at least one processing unit, the instructions, when executed by the at least one processing unit, causing the electronic device to perform operations comprising:
in response to receiving a user query, determining a plurality of matching degrees between the user query and a plurality of query modes;
determining, based on the plurality of matching degrees, whether a query result for the user query is to comprise a predetermined type of content being generated based on at least one data source using a machine learning model;
in response to determining that the query result for the user query is to comprise the predetermined type of content, extracting target content matching with the user query from a content database comprising the predetermined type of content; and
causing the target content to be presented in a query result page for the user query according to a visual style corresponding to the predetermined type.

12. The electronic device of claim 11, wherein determining the plurality of matching degrees between the user query and the plurality of query modes comprises:
determining a first matching degree between the user query and a first query mode by determining, using a trained first machine learning model, a predicted probability of a query result in the query result page for the user query being clicked, the first query mode indicating whether a query result satisfies a user requirement corresponding to a user query;
determining a second matching degree between the user query and a second query mode by using a trained second machine learning model, the second query mode indicating that a user query is related to knowledge questioning and answering; and
determining a third matching degree between the user query and a third query mode using a trained third machine learning model, the third query mode indicating that a user query is related to information search.

13. The electronic device of claim 12, wherein determining the first matching degree between the user query and the first query mode comprises:
obtaining a plurality of query results matching with the user query, wherein the plurality of search results are to be presented in the query result page;
extracting at least one type of feature information of respective ones of the plurality of query results; and
determining, using the first machine learning model, the predicted probability of the query result in the query result page being clicked based on the at least one type of feature information of respective ones of the plurality of query results.

14. The electronic device of claim 12, wherein the second machine learning model and/or the third machine learning model are trained based on a target set of samples, the target set of samples comprises a plurality of sample queries and a plurality of labels, each label indicating a labeled matching degree between a corresponding sample query and the second query mode, and/or a labeled matching degree between a corresponding sample query and the third query mode.

15. The electronic device of claim 14, wherein the target set of samples is obtained by:
determining, using a language model and based on a first prompt input, at least one predicted matching degree between each sample query of a first set of sample queries and at least one of the second query mode or the third query mode, wherein the first prompt input indicates a rating requirement of the language model for the first set of sample queries, and the first set of sample queries have respective labeled matching degrees;
adjusting the first prompt input based on a difference between the labeled matching degree corresponding to each of the first set of sample queries and the predicted matching degree; and
determining, using the language model and based on the adjusted first prompt input, at least one predicted matching degree between each of a second set of sample queries and at least one of the second query mode or the third query mode, as a labeled matching degree of a sample query in the second set of sample queries.

16. The electronic device of claim 11, wherein determining, based on the plurality of matching degrees, whether the query result for the user query is to comprise the predetermined type of content comprises:
in response to determining that at least one matching degree of the plurality of matching degrees satisfies a corresponding first matching degree threshold, determining that the query result is to comprise the predetermined type of content.

17. The electronic device of claim 11, wherein causing the target content to be presented according to the visual style corresponding to the predetermined type comprises:
determining a presenting location of the target content in the query result page based at least on the plurality of matching degrees; and
causing the target content to be presented at the presenting location of the query result page according to the visual style corresponding to the predetermined type.

18. The electronic device of claim 17, wherein determining the presenting location of the target content in the query result page comprises:
determining whether a query result matching with the user query comprises content configured to be located at a specified presenting location; and
in response to determining that the query result matching with the user query comprises the content configured to be located at the specified presenting location, determining the presenting location of the target content as a further presenting location other than the specified presenting location based at least on the plurality of matching degrees.

19. The electronic device of claim 11, wherein the predetermined type of content in the content database is generated by:
generating a first answer and a second answer matching with a reference query using a machine learning model, wherein content comprised in the first answer is with more detail than content comprised in the second answer;
determining a retention policy for the first answer and the second answer based on respective quality scores of the first answer and the second answer; and
in response to the retention policy indicating that both the first answer and the second answer are retained, storing the first answer and the second answer in the content database as the predetermined type of content matching with the reference query.

20. A non-transitory computer-readable storage medium having a computer program stored thereon, the computer program being executable by a processor to cause the processor to perform operations comprising:
in response to receiving a user query, determining a plurality of matching degrees between the user query and a plurality of query modes;
determining, based on the plurality of matching degrees, whether a query result for the user query is to comprise a predetermined type of content being generated based on at least one data source using a machine learning model;
in response to determining that the query result for the user query is to comprise the predetermined type of content, extracting target content matching with the user query from a content database comprising the predetermined type of content; and
causing the target content to be presented in a query result page for the user query according to a visual style corresponding to the predetermined type.
